(19) United States
(12) Patent Application Publication
(10) Pub. No.: US 2015/0188970 A1
(43) Pub. Date: Jul. 2, 2015

(54) Methods and Systems for Presenting Personas According to a Common Cross-Client Configuration

(71) Applicant: Personify, Inc., Chicago, IL (US)

(72) Inventors: Sumant Kowshik, Champaign, IL (US); Glenn Francisco, Chicago, IL (US); Dennis Lin, Chicago, IL (US); David Scherba, Lincoln, NE (US); Will Kelleher, Chicago, IL (US); Sanjay Patel, Champaign, IL (US)

(73) Assignee: Personify, Inc., Chicago, IL (US)

(21) Appl. No.: 14/145,865

(22) Filed: Dec. 31, 2013

(51) Int. Cl. H04L 29/06; G06T 11/60; H04N 5/265

(52) U.S. Cl. CPC H04L 65/602; H04N 5/265; G06T 11/60; G06T 2200/24; G06T 2207/10016; G06T 2207/20221; G06T 2207/30196

(57) ABSTRACT

Disclosed herein are methods and systems for presenting personas according to a common cross-client configuration. An embodiment takes the form of a method that includes extracting a persona from video frames being received from a video camera. The method also includes transmitting an outbound stream of persona data that includes the extracted persona. The method also includes receiving at least one inbound stream of persona data, where the at least one inbound stream of persona data includes one or more other personas. The method also includes presenting a full persona set of the extracted persona and the one or more other personas on a user interface according to a common cross-client persona configuration. The method also includes presenting one or more shared-content channels on the user interface according to a common cross-client shared-content-channel configuration.

### BACKGROUND

Online data communications are quite prevalent and pervasive in modern society, and are becoming more so all the time. Moreover, developments in software, communication protocols, and peripheral devices (e.g., video cameras), along with developments in other computing disciplines, have collectively enabled and facilitated the inclusion of multimedia experiences as part of such communications. Indeed, the multimedia nature and aspects of a given communication session are often the focus and even essence of such communications. These multimedia experiences take forms such as audio chats, video chats (that are usually also audio chats), online meetings (e.g., web meetings), and the like.

Using the context of online meetings as an illustrative example, it is often the case that one of the participants is the designated presenter, and often this designated presenter opts to include some visual materials as part of the offered presentation. Such visual materials may take the form of or at least include visual aids such as shared desktops, multiple-slide presentations, and the like. In some instances, from the perspective of another attendee at the online meeting, only such visual materials are presented on the display of the online meeting, while the presenter participates only as an audio voiceover. In other instances, the presenter may be shown in one region of the display while the visual materials are shown in another. And other similar examples exist as well.

### OVERVIEW

Improvements over the above-described options have recently been realized by technology that, among other capabilities and features, extracts what is known as a “persona” of the presenter from a video feed from a video camera that is capturing video of the presenter. The extracted persona, which in some examples appears as a depiction of the presenter from the torso up (i.e., upper torso, shoulders, arms, hands, neck, and head) is then visually combined by this technology with content such as a multiple-slide presentation, such that the presenter appears to the attendees at the online meeting to be superimposed over the content, thus personalizing and otherwise enhancing the attendees' experiences. This technology is described in the following patent documents, each of which is incorporated in its respective entirety into this disclosure: (i) U.S. patent application Ser. No. 13/083,470, entitled “Systems and Methods for Accurate User Foreground Video Extraction,” filed Apr. 8, 2011 and published Oct. 13, 2011 as U.S. Patent Application Pub. No. US2011/0249190, (ii) U.S. patent application Ser. No. 13/076,264, entitled “Systems and Methods for Embedding a Foreground Video into a Background Feed based on a Control Input,” filed Mar. 30, 2011 and published Oct. 6, 2011 as U.S. Patent Application Pub. No. US2011/0242277, and (iii) unpublished U.S. patent application entitled “System and Methods for Persona Identification Using Combined Probability Maps,” filed Dec. 31, 2013 and having Attorney Docket No. PFY-71210US01.

As mentioned, this persona extraction is carried out with respect to video data that is being received from a camera that is capturing video of a scene in which the presenter is positioned. The persona-extraction technology substantially continuously (e.g., with respect to each frame) identifies which pixels represent the presenter and which pixels do not, and accordingly generates “alpha masks” (e.g., generates an alpha mask for each frame), where a given alpha mask may take the form of or at least include an array with a respective stored data element corresponding to each pixel in the corresponding frame, where such stored data elements are individually and respectively set equal to 1 (one) for each presenter pixel and to 0 (zero) for every other pixel (i.e., for each non-presenter (a.k.a. background) pixel).

The described alpha masks correspond in name with the definition of the “A” in the “RGBA” pixel-data format known to those of skill in the art, where “R” is a red-color value, “G” is a green-color value, “B” is a blue-color value, and “A” is an alpha value ranging from 0 (complete transparency) to 1 (complete opacity). In a typical implementation, the “0” in the previous sentence may take the form of a hexadecimal number such as 0x00 (equal to a decimal value of 0 (zero)), while the “1” may take the form of a hexadecimal number such as 0xFF (equal to a decimal value of 255); that is, a given alpha value may be expressed as an 8-bit number that can be set equal to any integer that is (i) greater than or equal to zero and (ii) less than or equal to 255. Moreover, a typical RGBA implementation provides for such an 8-bit alpha number for each of what are known as the red channel, the green channel, and the blue channel; as such, each pixel has (i) a red (“R”) color value whose corresponding transparency value can be set to any integer value between 0x00 and 0xFF, (ii) a green (“G”) color value whose corresponding transparency value can be set to any integer value between 0x00 and 0xFF, and (iii) a blue (“B”) color value whose corresponding transparency value can be set to any integer value between 0x00 and 0xFF. And certainly other pixel-data formats could be used, as deemed suitable by those having skill in the relevant art for a given implementation.

When merging an extracted persona with content, the above-referenced persona-based technology creates the above-mentioned merged display in a manner consistent with these conventions; in particular, on a pixel-by-pixel (i.e., pixel-wise) basis, the merging is carried out using pixels from the captured video frame for which the corresponding alpha-mask values equal 1, and otherwise using pixels from the content. Moreover, it is noted that pixel data structures typically also include or are otherwise associated with one or more other values corresponding respectively to one or more other properties of the pixel, where brightness is an example of one such property. In some embodiments, the brightness value is the luma component of the image or video frame. In other embodiments, the brightness value is the pixel values of one of an R, G, or B color channel, or other similar color space (e.g., gamma compressed RGB, or R′G′B′, or YUV, or YCbCr, as examples). In other embodiments, the brightness value may be a weighted average of pixel values from one or more color channels. And other approaches exist as well.

This disclosure describes systems and methods for presenting personas according to a common cross-client configuration. Such systems and methods are useful for scenarios such as, for example, an online “panel discussion” or more generally an online meeting or other online communication session during which it is encouraged and expected that multiple attendees will be actively speaking and otherwise participating. The present systems and methods facilitate such interaction by enabling the presentation of multiple personas according to a first common configuration, and further by enabling the presentation of one or more shared-content channels (e.g., windows, documents, pictures, videos, and the like) according to a second common configuration.

The present systems and methods therefore provide a unified and uniform experience for each of the participants in such a communication session. Thus, in a context in which multiple participants in such an online collaboration are each using a computing system that is carrying out (i.e., implementing, executing, and the like) the present systems and methods, a shared experience is had by all such participants; in that shared experience, each participant observes the same screen view on their respective computing system (desktop, laptop, tablet, or the like): the various personas in the meeting appear on each respective display in the same position (i.e., in the same absolute position on computing systems having identical displays, or in the same relative position on computing systems having non-identical displays) with respect to one another, with respect to the overall display, and with respect to any shared-content channels (e.g., windows); and the same is true of any shared-content channels (e.g., windows), which appear on each respective display in the same position (again, in the same absolute position on computing systems having identical displays, or in the same relative position on computing systems having non-identical displays) with respect to one another, with respect to the overall display, and with respect to the displayed full persona set. As such, each participant derives convenience, comfort, and confidence from the knowledge that gestures (e.g., pointing to things on the display) and/or other actions that they make with their persona with respect to elements on their display will appear to each other participant on their respective displays the way that such gestures and/or other actions appear to them on their own display.

One embodiment takes the form of a method that includes extracting a persona from video frames being received from a video camera. The method also includes transmitting an outbound stream of persona data that includes the extracted persona. The method also includes receiving at least one inbound stream of persona data that includes one or more other personas. The method also includes presenting a full persona set of the extracted persona and the one or more other personas on a user interface according to a common cross-client persona configuration, and further includes presenting one or more shared-content channels on the user interface according to a common cross-client shared-content-channel configuration.

Another embodiment takes the form of a computing system that includes a persona-extraction module configured to extract a persona from video frames being received from a video camera. The computing system also includes a persona-transmission module configured to transmit an outbound stream of persona data comprising the extracted persona. The computing system also includes a persona-reception module configured to receive at least one inbound stream of persona data, where the at least one inbound stream of persona data includes one or more other personas. The computing system also includes a persona-set-presentation module configured to present the extracted persona and the one or more other personas on a user interface according to a common cross-client persona configuration, and further includes a shared-content-channel-presentation module configured to present one or more shared-content channels on the user interface according to a common cross-client shared-content-channel configuration.

The preceding paragraph is an example of the fact that, in the present disclosure, various elements of one or more of the described embodiments are referred to as modules that carry out (i.e., perform, execute, and the like) various functions described herein. As the term “module” is used herein, each described module includes or at least has access to any necessary hardware (e.g., one or more processors, microprocessors, microcontrollers, microchips, application-specific integrated circuits (ASICs), field programmable gate arrays (FPGAs), memory devices, and/or one or more of any other type or types of devices and/or components deemed suitable by those of skill in the relevant art in a given context and/or for a given implementation. Each described module also includes or at least has access to any necessary instructions executable for carrying out the one or more functions described as being carried out by the particular module, where those instructions could take the form of or at least include hardware (i.e., hardwired) instructions, firmware instructions, software instructions, and/or the like, stored in any non-transitory computer-readable medium deemed suitable by those of skill in the relevant art.

The remaining paragraphs in this overview section pertain to various variations and permutations that are present in various embodiments of the present systems and methods, and these variations apply with equal force to method embodiments and system embodiments.

In at least one embodiment, receiving the at least one inbound stream of persona data involves receiving a single inbound stream of persona data, where that single inbound stream of persona data includes the one or more other personas. In some such embodiments, receiving that single inbound stream of persona data involves receiving that single inbound stream of persona data from a server that compiled multiple persona streams into the single inbound stream of persona data.

In at least one embodiment, receiving the at least one inbound stream of persona data involves receiving multiple inbound streams of persona data from multiple sources, where each of those multiple inbound streams of persona data includes a respective one of the one or more other personas.

In at least one embodiment, the at least one inbound stream of persona data includes audio data associated with the one or more other personas, and presenting the full persona set on the user interface involves presenting the audio data associated with the one or more other personas.

At least one embodiment involves not presenting audio data associated with the extracted respective persona via the user interface.

In at least one embodiment, the at least one inbound stream of persona data includes presentation metadata conveying the common cross-client persona configuration. In at least one embodiment, the common cross-client persona configuration specifies positioning data and size data for each persona in the full persona set. In at least one such embodiment, the common cross-client persona configuration specifies a positioning offset and a size of a respective display region for each persona in the full persona set. In at least such embodiment, the common cross-client persona configuration specifies a respective in-region positioning offset for each persona in that persona's respective display region.

In at least one embodiment, the common cross-client persona configuration places the personas in the full persona set in a horizontal row in which the personas are sequenced in a particular order.

In at least one embodiment, the common cross-client persona configuration specifies respective display sizes for the various personas, where those respective display sizes are based on normalization of depth values respectively associated with the personas.

In at least one embodiment, presenting the full persona set on the user interface involves presenting a local copy of the extracted persona.

At least one embodiment involves formatting the extracted persona for transmission in the outbound stream of persona data as including frames consisting of a chroma key surrounding the extracted persona.

At least one embodiment involves identifying the one or more other personas in the at least one inbound stream of persona data at least in part by identifying and removing chroma keys included with the one or more other personas in the at least one inbound stream of persona data. At least one such embodiment further involves using the identified chroma keys for generating respective alpha masks for the one or more other personas in the at least one inbound stream of persona data, as well as using the generated alpha masks for presenting the associated personas as part of presenting the full persona set on the user interface.

At least one embodiment involves transmitting an outbound shared-content-channel stream corresponding to a given shared-content channel to one or more other computing systems, where that outbound shared-content-channel stream includes appearance data for the given shared-content channel and display-configuration data for use by each of the one or more other computing systems in presenting the shared-content channel in accordance with the common shared-content-channel configuration. In at least one such embodiment, the at least one inbound stream of persona data has a frame rate that exceeds that of the outbound shared-content-channel stream. In at least one other such embodiment, the appearance data for the given shared-content channel reflects an appearance of a native application window currently being displayed on the user interface.

In at least one embodiment, presenting a given shared-content channel on the user interface involves receiving an inbound shared-content-channel stream corresponding to the given shared-content channel, where the inbound shared-content-channel stream includes appearance data and display-configuration data for the given shared-content channel, and further involves using the display-configuration data for the given shared-content channel to display the appearance data for the given shared-content channel in accordance with the common cross-client shared-content-channel configuration. In at least one such embodiment, the at least one inbound stream of persona data has a frame rate that exceeds that of the inbound shared-content-channel stream.

At least one embodiment involves operating in a featured-speaker mode in which one or more of the personas in the full persona set are designated as featured-speaker personas, the remaining personas in the full persona set are non-featured-speaker personas, and the common cross-client persona configuration emphasizes each featured-speaker persona. In at least one such embodiment, the common cross-client persona configuration deemphasizes each non-featured-speaker persona.

In at least one embodiment, the common cross-client shared-content-channel configuration specifies positioning data and size data for each of the one or more shared-content channels.

In at least one embodiment, the common cross-client shared-content-channel configuration specifies relative positioning data among multiple shared-content channels.

In at least one embodiment, the common cross-client shared-content-channel configuration specifies relative positioning data between (i) one or more personas and (ii) one or more shared-content channels.

The above overview is provided by way of example and not limitation, as those having ordinary skill in the relevant art may well implement the disclosed systems and methods using one or more equivalent components, structures, devices, and the like, and may combine and/or distribute certain functions in equivalent though different ways, without departing from the scope and spirit of this disclosure.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 depicts aspects of an example scenario in which multiple computing systems are communicatively connected via a network.

FIG. 2 depicts aspects of a structure of an example computing system.

FIG. 3 depicts aspects of an example video camera.

FIG. 4 depicts aspects of an example computing system.

FIG. 5 depicts aspects of an example information flow involving the example computing system of FIG. 4.

FIG. 6 depicts aspects of a first example information flow between and among multiple computing systems and a server.

FIG. 7 depicts aspects of a second example information flow between and among multiple computing systems and a server.

FIG. 8 depicts aspects of the example scenario that is depicted in FIG. 1 where a featured-speaker mode is enabled.

FIG. 9 depicts an example method.

### DETAILED DESCRIPTION

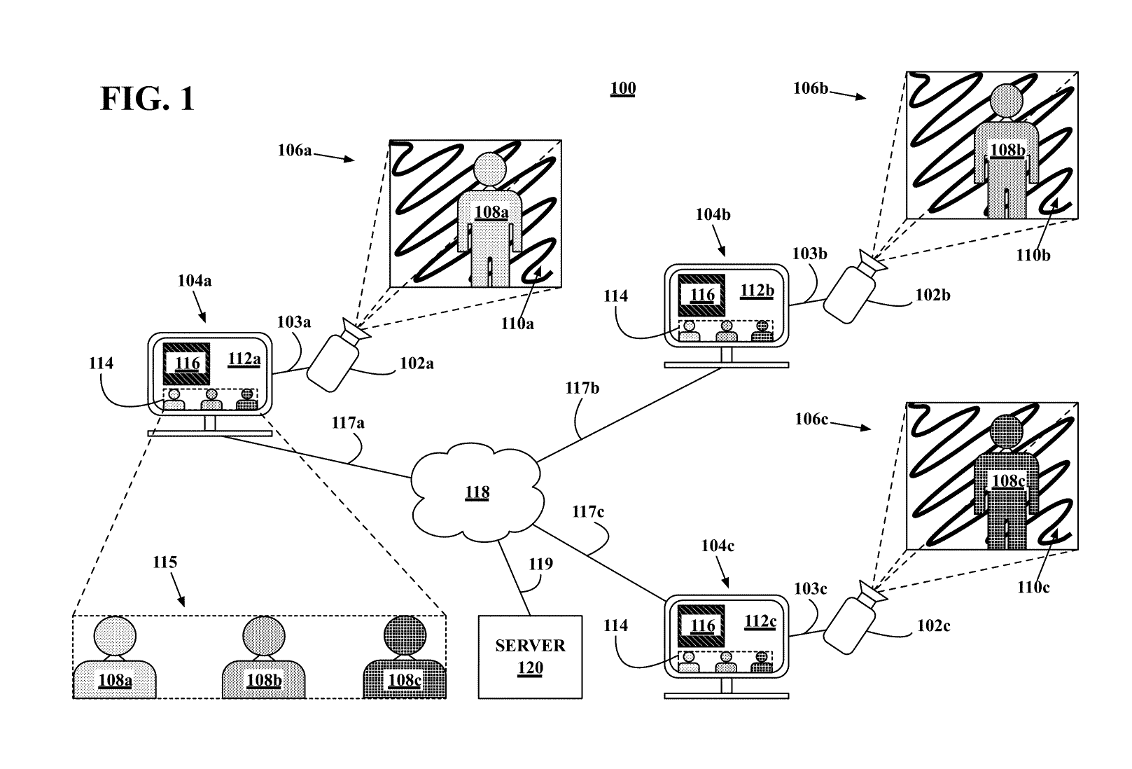

FIG. 1 depicts aspects of an example scenario in which multiple computing systems are communicatively connected via a network. In particular, FIG. 1 depicts a scenario 100 in which computing systems 104a, 104b, and 104c are each communicatively connected to a network 118, to which a server 120 is also connected. The computing system 104a is communicatively connected at 117a to the network 118, and is also connected at 103a to a video camera 102a that is capturing video of a scene 106a. From that video, the computing system 104a operates to extract a persona 108a to the exclusion of a background 110a. The computing system 104a includes a user interface that itself includes a display 112a. In the example depicted in FIG. 1, the display 112a is presenting a full persona set 114 and a set of one or more shared-content channels 116, both of which are further described below. As shown at the enlargement 115 of the full persona set 114, the full persona set 114 includes, from left to right, the persona 108a, a persona 108b that is being captured by the computing system 104b, and a persona 108c that is being captured by the computing system 104c.

In the example depicted in FIG. 1, each of the computing systems 104b and 104c have respective connections 117b and 117c to the network 118, respective connections 103b and 103c to respective video cameras 102b and 102c that are capturing respective video of respective scenes 106b and 106c. And from those respective video streams, the computing systems 104b and 104c are operating to extract the respective personas 108b and 108c to the respective exclusion of respective backgrounds 110b and 110c. Moreover, the computing systems 104b and 104c have respective user interfaces that include respective displays 112b and 112c that, like the display 112a of the computing system 104a, are each presenting the full persona set 114 (in the same left-to-right, persona 108a, persona 108b, persona 108c configuration) as well as the one or more shared-content channels 116.

Thus, the respective user experiences provided by the respective computing systems 104a, 104b, and 104c are coordinated at least in terms of (i) display of relative size and relative arrangement of the personas in the full persona set 114, (ii) display of relative size and relative arrangement of the one or more shared-content channels 116, and (iii) relative display of the full persona set 114 and the one or more shared-content channels 116. The network 118 could be or at least include one or more packet-switched data networks such as the worldwide network of networks that is commonly referred to as the Internet.

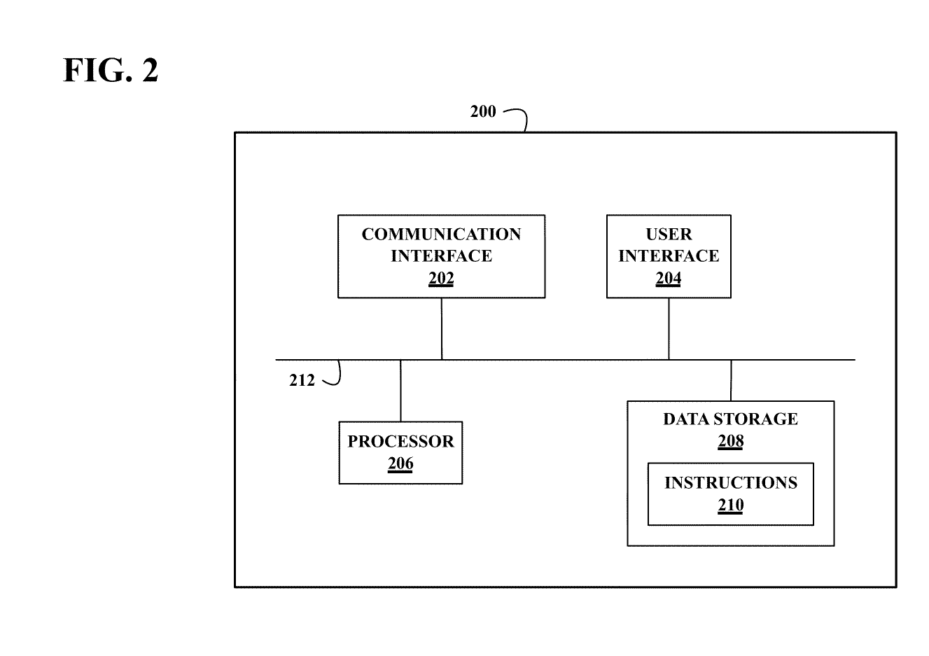

FIG. 2 depicts aspects of a structure of an example computing system 200 as including a communication interface 202, a user interface 204, a processor 206, and a data storage 208 containing executable instructions 210, all of which are communicatively connected by a system bus 212 (or other suitable communication mechanism (e.g., network)). The computing system 200 is presented as a general example of a computing system; one or more systems, devices and the like presented in this disclosure may have a structure and arrangement similar to that of the computing system 200. Examples of such systems and devices disclosed herein include the computing system 104a, the computing system 104b, the computing system 104c, and the server 120.

The communication interface 202 may include any number of wired-communication interfaces (e.g., Ethernet, Universal Serial Bus (USB), and/or the like) and/or any number of wireless-communication interfaces (e.g., Wi-Fi, cellular, Bluetooth, RF, infrared, and/or the like) for engaging in wired or wireless communication, respectively.

The user interface 204 may include one or more user-interface components for receiving inputs from users, such as one or more touchscreens, one or more microphones, one or more keyboards, one or more mice, and/or one or more of any other type or types of user-input devices and/or components deemed suitable by those of skill in the art for a given implementation. The user interface 204 may also or instead include one or more user-interface components for conveying outputs to users, such as one or more displays, one or more speakers, one or more light emitting diodes (LEDs) or other similar indicators, and/or one or more of any other type or types of user-output devices and/or components deemed suitable by those of skill in the art for a given implementation.

The processor 206 may include one or more processors of any type or types deemed suitable by those of skill in the relevant art, with some representative examples including microprocessors, central processing units (CPUs), digital signal processors (DSPs), image signal processors (ISPs), and the like.

The data storage 208 may include one or more instances of one or more types of non-transitory data storage deemed suitable by those having skill in the relevant art, with some representative examples including read-only memory (ROM), random-access memory (RAM), disk-based storage, flash memory, optical-storage technology, and the like. In at least one embodiment, the data storage 208 contains the instructions 210 that are executable by the processor 206 for carrying out at least the functions described herein as being carried out by the particular computing system (e.g., 104a, 104b, 104c, the server 120, and so on).

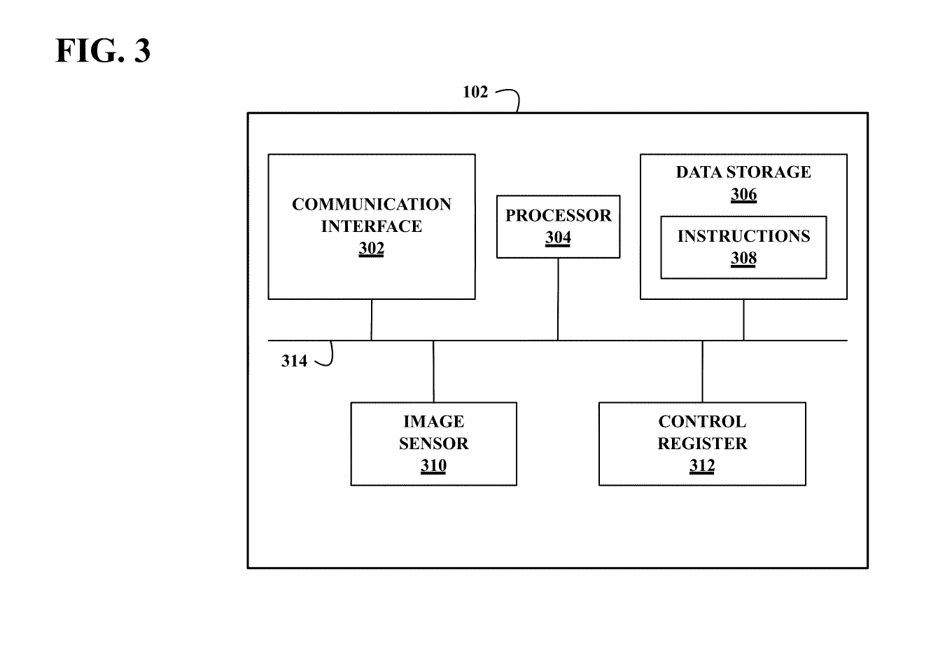

FIG. 3 depicts aspects of an example video camera. In particular, FIG. 3 depicts aspects of the video cameras 102 (i.e., 102a, 102b, and 102c) of FIG. 1 as including, in at least one embodiment, a communication interface 302, a processor 304, a data storage 306 containing executable instructions 308, an image sensor 310, and a control register 312, all of which are communicatively connected by a system bus 314 (or other suitable communication mechanism (e.g., network)). The video camera 102 could be a standalone device, but could also be a peripheral device of—and/or incorporated into—one or more other devices or systems (e.g., the corresponding computing system 104).

The communication interface 302, the processor 304, the data storage 306, the instructions 308 (in form as opposed to content), and the system bus 314 may take respective forms similar to the correspondingly named components that are described in connection with FIG. 2, and therefore are not described in as great of detail here. In an embodiment, the image sensor 310 includes a hardware image sensor configured to convert an optical image into an electronic signal. In an embodiment, the control register 312 includes one or more hardware registers that are associated with respective adjustable video-capture settings (e.g., exposure, gain, and the like) of the video camera 102.

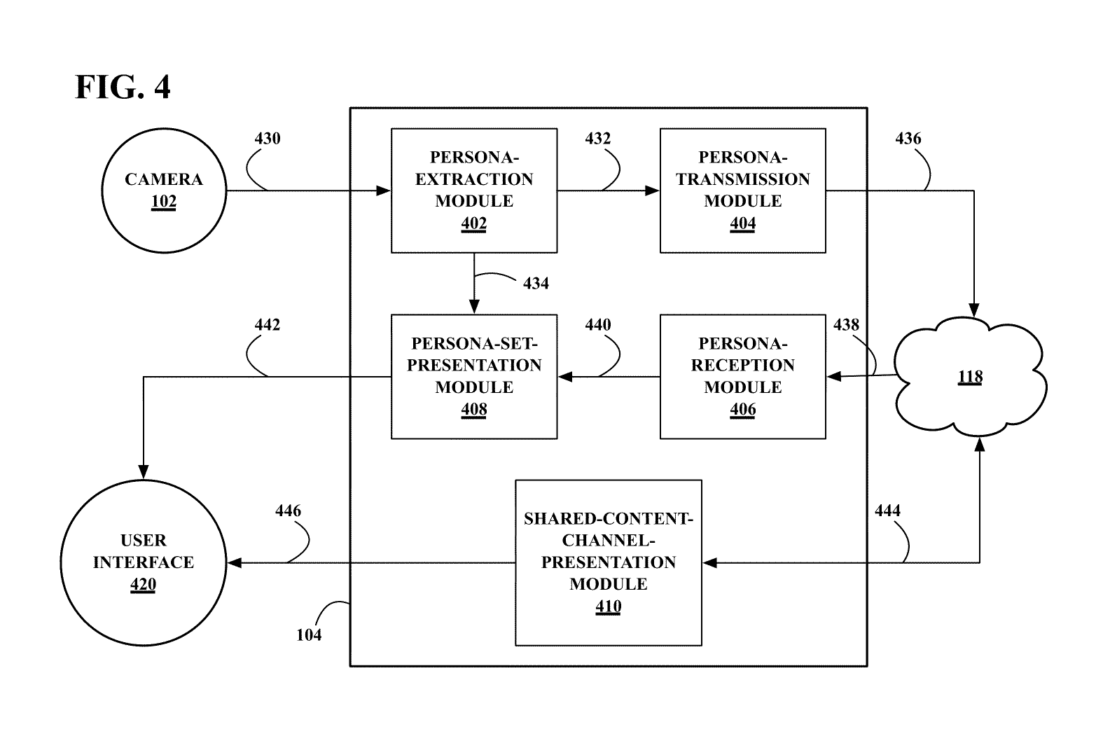

FIG. 4 depicts aspects of an example computing system. In particular, FIG. 4 depicts aspects of the computing system 104 (i.e., 104a, 104b, and/or 104c) of FIG. 1 as including a persona-extraction module 402, a persona-transmission module 404, a persona-reception module 406, a persona-set-presentation module 408, and a shared-content-channel presentation module 410.

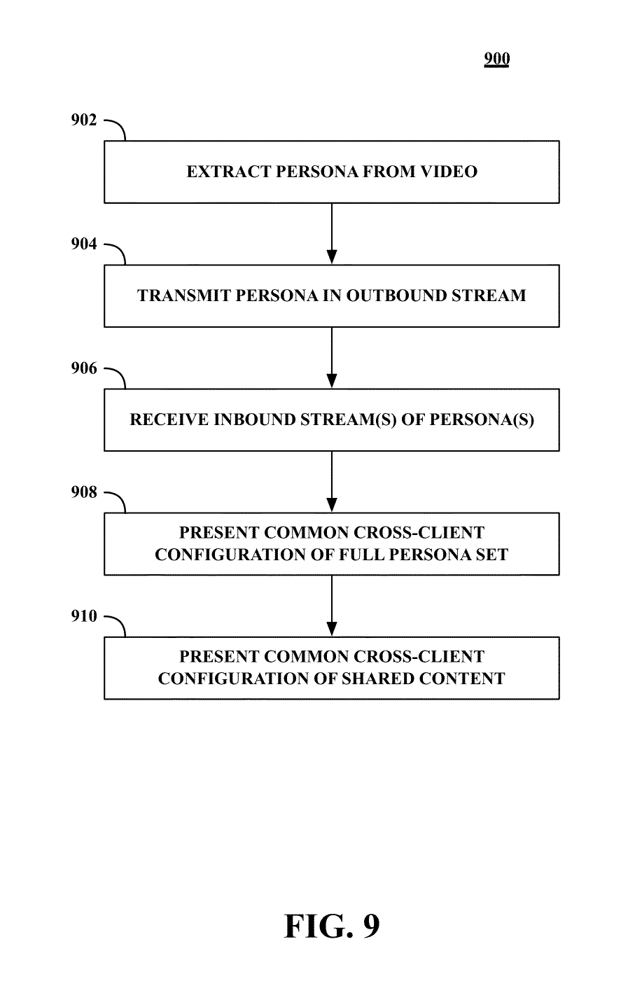

In at least one embodiment, the persona-extraction module 402 is configured to carry out at least the functions described below in connection with step 902 of FIG. 9, and is depicted in FIG. 4 as (i) receiving video frames from the video camera 102 (at 430) and (ii) transmitting an extracted persona to the persona-transmission module 404 (at 432) and also to the persona-set-presentation module 408 (at 434). In general, the captured video comprises a background portion and a foreground portion, where the background portion may comprise a wall, outdoor scene, or any other background scene and the foreground portion may comprise a human user or presenter. Persona extraction is performed to identify the foreground portion such that the user image may be extracted and displayed without the background pixel data. In some embodiments, persona-identification modules may be used to analyze (i) depth information, (ii) image pixel information, or both, to generate a plurality of foreground-background probability maps. The maps may then be aggregated into a single probability map that is then processed by the persona-extraction module 402, which may utilize a graph cut algorithm, an active-contour algorithm, an active shape algorithm, or a combination thereof, to identify the pixels of an image frame that correspond to a user persona. The above documents that are incorporated by reference provide additional examples of persona extraction.

In at least one embodiment, the persona-transmission module 404 is configured to carry out at least the functions described below in connection with step 904 of FIG. 9, and is depicted in FIG. 4 as (i) receiving the extracted persona from the persona-extraction module 402 (at 432) and (ii) transmitting the extracted persona (perhaps after processing the extracted persona through one or more operations such as vocoding, encryption, compression, chroma-key application, and the like) to the network 118 (at 436).

In at least one embodiment, the persona-reception module 406 is configured to carry out at least the functions described below in connection with step 906 of FIG. 9, and is depicted in FIG. 4 as (i) receiving an inbound stream of one or more other personas from the network 118 (at 406) and (ii) transmitting that inbound stream of one or more other personas to the persona-set-presentation module 408 (at 440).

In at least one embodiment, the persona-set-presentation module 408 is configured to carry out at least the functions described below in connection with step 908 of FIG. 9, and is depicted in FIG. 4 as (i) receiving the extracted persona from the persona-extraction module 402 (at 434), (ii) receiving the inbound stream of one or more other personas from the persona-reception module 406 (at 440), and (iii) presenting a full persona set via the user interface 420 (at 442).

In at least one embodiment, the shared-content-channel-presentation module 410 is configured to carry out at least the functions described below in connection with step 910 of FIG. 9, and is depicted in FIG. 4 as (i) receiving one or more shared-content-channel streams from—and/or transmitting one or more shared-content-channel streams to—the network 118 (at 444) and (ii) presenting one or more shared-content-channel streams via the user interface 420 (at 446).

Those having skill in the art will appreciate that the computing system 104 may include additional and/or different modules, that the modules 402, 404, 406, 408, and 410 may perform additional and/or different functions, and/or additional and/or different communication paths and links could be implemented, as the arrangement described herein is provided by way of example and not limitation.

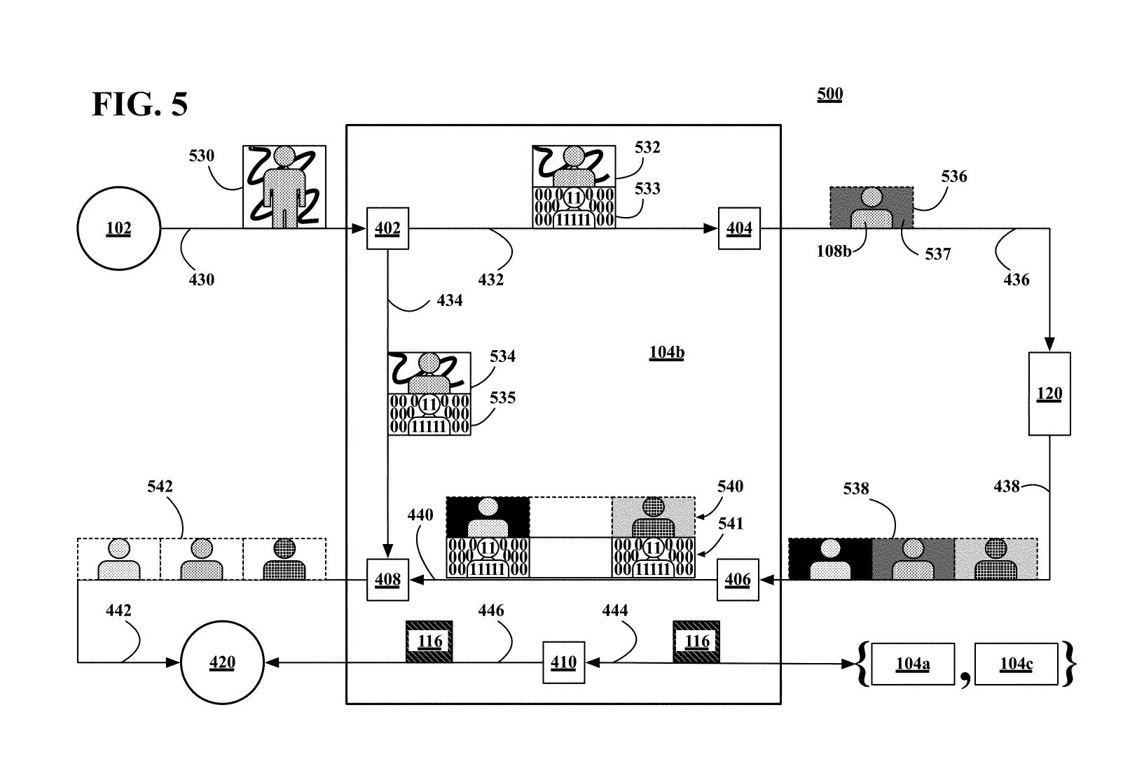

FIG. 5 depicts aspects of an example information flow involving the example computing system 104 of FIG. 4, with particular reference to the computing system 104b in the example 500 that is presented in FIG. 5. It is noted that FIG. 5 parallels FIG. 4 in many respects, and as such the focus in this description of FIG. 5 is on aspects that are depicted in FIG. 5 and that are not as explicitly depicted in FIG. 4.

At 430, the persona-extraction module 402 receives a stream 530 of video frames from the camera 102. As shown in FIG. 5, the stream 530 of video frames is representative generally of the appearance of the scene 106b that is depicted in FIG. 1. At 432, the persona-extraction module 402 transmits at least a cropped video stream 532 (cropped, i.e., from the video stream 530) and a corresponding stream 533 of alpha masks generated by the persona-extraction module 402 by identifying the persona 108b from the video stream 530 (e.g., from image-depth data received as part of the video stream 530). At 434, the persona-extraction module 402 transmits copies 534 and 535 of the streams 532 and 533, respectively, to the persona-set-presentation module 408.

At 436, the persona-transmission module 404 transmits an outbound stream 536 of persona data to the server 120 via the network 118. The outbound persona stream 536 includes the extracted persona 108b. In various different embodiments, the outbound persona stream 536 is generated by the persona-transmission module 404 using one or more operations such as vocoding, encryption, compression, chroma-key application, and the like.

In at least one embodiment, as depicted in FIG. 5, the outbound persona stream 536 includes the extracted persona 108b surrounded by a chroma key 537. In at least one embodiment, the persona-transmission module 404 generates the outbound persona stream 536 at least in part by applying the stream 533 of alpha masks (e.g., on a frame-by-frame basis) to the stream 532 of video frames, generating frames for the stream 536 having pixels from the stream 532 of video frames for pixel locations for which the corresponding value in the stream 533 of alpha masks is equal to 1, and otherwise using pixels of the color corresponding to the selected chroma key. Often a particular chroma key will be selected in a color that is extremely underrepresented (if not completely unrepresented) among the pixels in the extracted persona, such that a later process of filtering out the chroma key will leave the pixels in the extracted persona largely (or perhaps completely) unaltered (at least as to color).

In one sense, a chroma key is metadata in a given video frame or video stream, in that the chroma key is typically encoded as the top-left pixel in the given video frame or video stream, somewhat akin to a packet header, and indicates to a decoder which color to filter out of the given video frame or video stream. In another sense, however, the chroma key is simply substantive data in the video frame or video stream along with all of the other pixels in the given video frame or video stream, and as such is a good candidate for data compression prior to transmission, in that a chroma key quite often manifests as relatively lengthy strings of consecutive identical pixels in the given video frame or video stream. Chroma keys can thus be accurately characterized as representing an advantageous duality as highly useful metadata and highly compressible substantive data.

At 438, the persona-reception module 406 receives an inbound stream 538 of persona data from the server 120 via the network 118. In the example that is depicted in FIG. 5, the inbound stream 538 of persona data includes the three personas 108a, 108b, and 108c that are depicted in FIG. 1. In at least one embodiment, and as depicted in FIG. 5, the inbound stream 538 of persona data includes the multiple personas arranged in a single video stream in which each of the three personas are surrounded in a respective rectangular region of the single video stream by a respective chroma key, where one or more of the personas could be surrounded by the same chroma key, or where each respective persona could be surrounded by a different chroma key.

At 440, in at least one embodiment, the persona-reception module 406 transmits, to the persona-set-presentation module 408, streams 540 of the received inbound set of personas and 541 of corresponding alpha masks. In at least one embodiment, the persona-reception module 406 generates the stream 541 of corresponding alpha masks by identifying chroma keys from the top-left pixels of the corresponding video frames, and then populating corresponding alpha masks with 0s for the pixel locations that match the color of the chroma key and with 1s for all other pixel locations.

At 442, the persona-set-presentation module 408 presents a full persona set 542 via the user interface 420. The full persona set 542 includes, from left to right in a horizontal row, the personas 108a, 108b, and 108c. In at least one embodiment, as depicted in FIG. 5, the persona-set-presentation module 408 receives a locally generated copy of the persona 108b from the persona-extraction module 402 at 434, and receives remotely generated copies of the personas 108a and 108c from the persona-reception module 406 at 440.

In at least one embodiment, the persona-set-presentation module 408 uses the streams 534 and 535 to render pixels corresponding to the persona 108b, and uses the streams 540 and 541 to render pixels corresponding to the personas 108a and 108c. In at least one embodiment, the persona-set-presentation module 408 generates a single window containing a combined video stream of the three personas, where substantially every (if not every) non-persona pixel (including pixels typically used for window elements such as title bars, menus, and the like) is set to be substantially completely (if not completely) transparent.

At 444, the shared-content-channel-presentation module 410 (i) transmits one or more shared-content channels 116 to the computing systems 104a and the computing system 104c and/or (ii) receives one or more shared-content channels 116 from the computing system 104a and/or the computing system 104c. At 446, the shared-content-channel-presentation module 410 presents one or more shared-content channels 116 via the user interface 420.

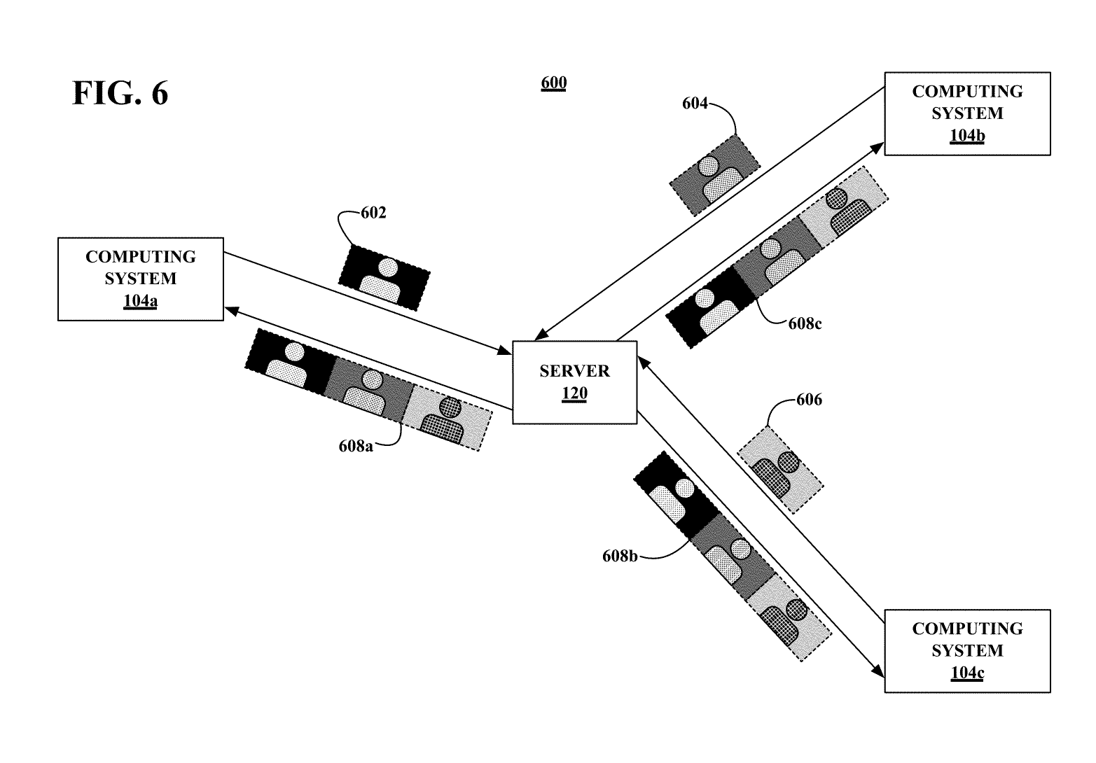

FIG. 6 depicts aspects of a first example information flow between and among multiple computing systems and a server. In particular, FIG. 6 depicts an example information flow 600 between and among the computing system 104a, the computing system 104b, the computing system 104c, and the server 120. At 602, the computing system 104a transmits to the server 120 a stream that includes the persona 108a surrounded by a chroma key. At 604, the computing system 104b transmits to the server 120 a stream that includes the persona 108b surrounded by a chroma key. At 606, the computing system 104c transmits to the server 120 a stream that includes the persona 108c surrounded by a chroma key. At 608a, 608b, and 608c, the server 120 transmits to the computing system 104a, the computing system 104b, and the computing system 104c, respectively, a video stream that includes, arranged from left to right in a single horizontal row, the persona 108a surrounded by its respective chroma key, the persona 108b surrounded by its respective chroma key, and the persona 108c surrounded by its respective chroma key.

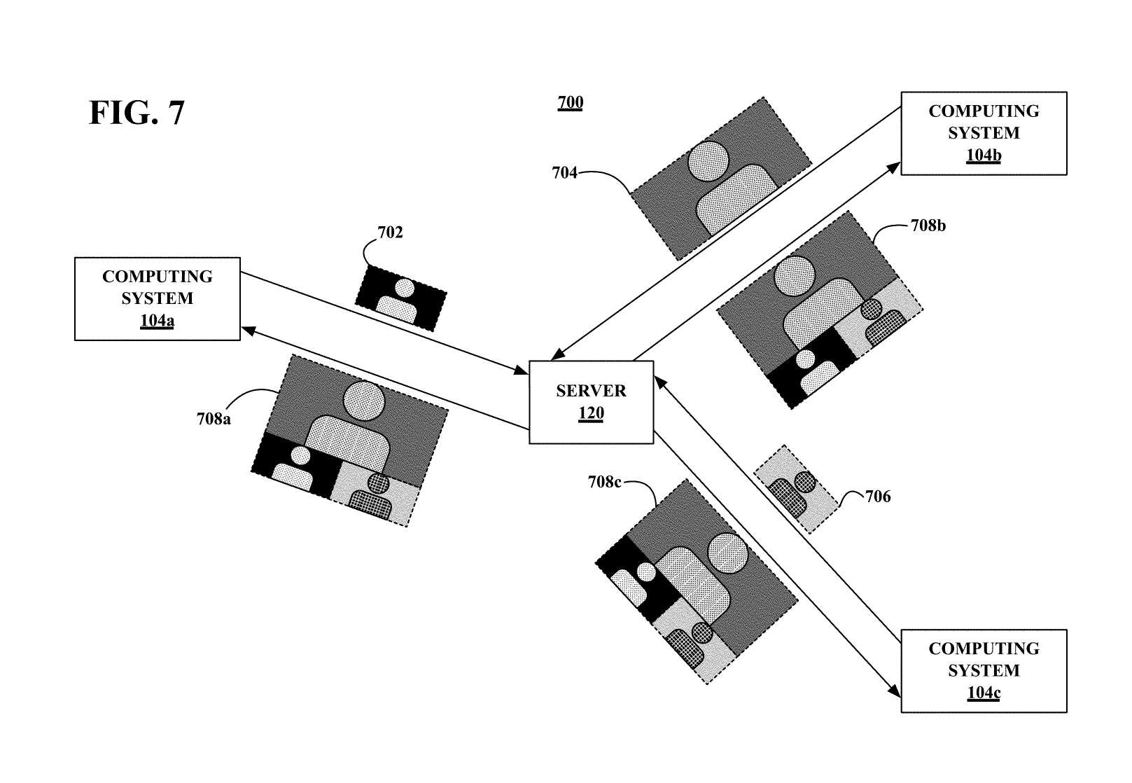

FIG. 7 depicts aspects of a second example information flow between and among multiple computing systems and a server. In particular, FIG. 7 depicts an example information flow 700 that is similar in many respects to the example information flow 600 depicted in FIG. 6. The information flow 700 differs from the information flow 600 in that the information flow 700 involves a mode referred to herein as featured-speaker mode, and in particular shows an example where the computing system 104b corresponds to a featured-speaker persona 108b while the computing systems 104a and 104c correspond to non-featured-speaker personas 108a and 108c, respectively. The computing system 104a transmits the non-featured-speaker persona 108a to the server 120 at 702. The computing system 104b transmits the featured-speaker persona 108b to the server 120 at 704. And the computing system 106 transmits the non-featured-speaker persona 108c to the server 120 at 706.

The featured-speaker mode is further discussed below, though it can be seen that in at least the embodiment that is depicted in FIG. 7, the featured-speaker persona 108b is larger in size (e.g., in amount of video data, in resolution, and the like) than the non-featured-speaker personas 108a and 108c, and is transmitted from the computing system 104b to the server 120 as such. In some embodiments, even when operating in the featured-speaker mode, the computing system 104b transmits the persona 108b to the server 120 at the same size and resolution that the computing system 104b would use when not operating in the featured-speaker mode; in such embodiments, any emphasis applied to the featured-speaker persona 108b for presentation is implemented by some combination of the server 120 and/or other computing systems (including the computing system 104b when displaying the persona 108b).

Moreover, in the depicted example, the rectangular video feed that is transmitted from the server 120—to the computing system 104a at 708a, to the computing system 104b and 708b, and to the computing system 104c at 708c—includes the featured-speaker persona 108b formatted in a large upper rectangular section while the non-featured-speaker personas 108a and 108c are formatted in respective smaller lower-left and lower-right rectangular sections. And certainly other approaches could be used, as the information flows 600 and 700 are presented for illustration by way of example and not limitation.

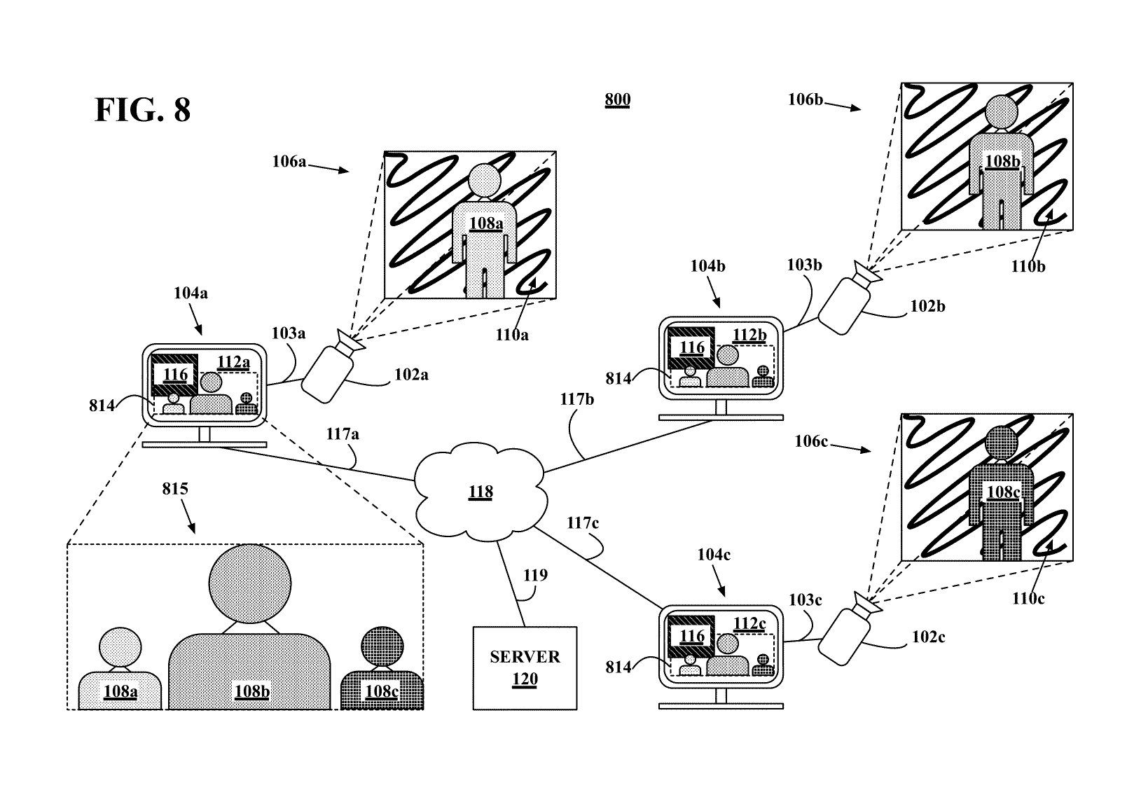

FIG. 8 depicts aspects of the example scenario that is depicted in FIG. 1 where the featured-speaker mode is enabled. The example scenario 800 that is depicted in FIG. 8 is similar in many respects to the example scenario 100 that is depicted in FIG. 1, and thus is not described in as great of detail. As can be seen in FIG. 8, the presented full persona set 814 (shown enlarged at 815) includes the featured-speaker persona 108b displayed larger than the non-featured-speaker personas 108a and 108c. The persona 108b is centered in both the full persona set 114 of FIG. 1 and the full persona set 814 of FIG. 8. If, however, a given persona that was not initially centered became a featured-speaker persona for some period of time, that given persona could then be displayed in a centered position (and/or emphasized in one or more other ways) for at least that period of time, after which the various personas may be returned to a previous configuration, though the various personas could instead remain arranged in the new sequence, perhaps with no particular emphasis applied to any one persona. And certainly other implementations and design choices could be made by those in the art.

Moreover, FIGS. 6-8, and more particularly FIGS. 6 and 7, depict embodiments according to which each of the computing systems 104 sends a respective persona to the server 120, which then arranges those received multiple personas into a full persona set, and then transmits to each of the participating computing systems 104 data (e.g., video data) and metadata that each given computing system 104 (e.g., the computing system 104b) uses to display the full persona set according to the common cross-client persona configuration. In some embodiments, however, a central server (e.g., the server 120) is not present; in those embodiments, each participating computing system communicates in a peer-to-peer manner with each other participating computing system. For example, the computing system 104b communicates in a peer-to-peer manner with the computing system 104a, and in a peer-to-peer manner with the computing system 104c. In such embodiments, each such computing system arranges the personas in the full persona set according to a pre-defined set of conventions (e.g., arranged from left to right in order of joining the online meeting, or arranged from left to right in alphabetical order by username, by e-mail address, and/or the like). And certainly other peer-to-peer approaches could be implemented as deemed suitable by those of skill in the relevant art for a given implementation or in a given context.

Furthermore, as needed, conflict-resolution rules could be pre-defined as well; for example, if the computing system 104b receives information from the computing system 104a that is inconsistent with information that the computing system 104b already had and/or received from the computing system 104c regarding, for example, which persona or personas should be featured-speaker personas at that time, which order to display the personas in, and/or regarding one or more other aspects of the session, the computing system 104b could resolve such conflicts according to the order in which the personas joined the meeting, or in some alphabetical order, or by using some other conflict-resolution approach deemed suitable by those of skill in the art for a given peer-to-peer implementation.

In still further embodiments, a persona positioning message flow is provided by which any given user (or a subset, such as only a presenter) may initiate a repositioning or reordering of personas. In one such embodiment, a user may select his persona and drag it to a new location causing a reordering of the displayed personas on the displays of the participating computing devices. The computing system of the initiator then composes a persona positioning request message for transmission to the server or to its peers to indicate the user's preference of persona locations. The server and/or the peer computing systems may then use the metadata in the persona positioning request message to reorder or rearrange the displayed personas. The computing systems may also be configured to provide an acknowledgment of the persona positioning request message.

FIG. 9 depicts an example method. In particular, FIG. 9 depicts a method 900 that in at least one embodiment is carried out by a computing system. For illustration and not by way of limitation, the method 900 is described here as being carried out by the computing system 104b that is referenced in the preceding figures.

At step 902, the computing system 104b extracts the persona 108b from the video frames 530 being received (at 430) from the video camera 102b. In an embodiment, and as described above, step 902 involves processing at least image-depth data of the video frames 530, generating alpha masks corresponding to the persona for at least a cropped portion 532 of the video frames 530, and then sending (at 432) at least the cropped portion 532 and the stream 533 of corresponding alpha masks from the persona-extraction module 402 to the persona-transmission module 404. In the example depicted and described above, the persona-extraction module 402 also sends (at 434) copies 534 and 535 of the cropped video stream and the corresponding alpha masks, respectively, to the persona-set-presentation module 408.

At step 904, the computing system 104b transmits (at 436) the outbound stream 536 of persona data (via, e.g., one or more ports configured by the computing system 104b for transmitting one or more outbound streams of persona data), where that outbound stream 536 includes the extracted persona 108b. In at least one embodiment, the computing system 104b formats the extracted persona 108b for transmission in the outbound stream 536 as including frames consisting of the chroma key 537 surrounding the extracted persona 108b.

At step 906, the computing system 104b receives (at 438) at least one inbound stream 538 of persona data (via, e.g., one or more ports configured by the computing system 104b for receiving one or more inbound streams of persona data), where the at least one inbound stream 538 of persona data includes one or more other personas; for example, in the example depicted in FIG. 5, the computing system 104b receives the inbound stream 538 that includes the personas 108a and 108c. In that example and in various other embodiments, step 906 involves receiving a single inbound stream (e.g., the inbound stream 538) that includes the one or more other personas. In some such embodiments, step 906 involves receiving a single inbound stream (e.g., the inbound stream 608c of FIG. 6) of persona data from a server (e.g., the server 120) that compiled multiple persona streams (e.g. the persona streams 602, 604, and 606 of FIG. 6) into the single inbound stream of persona data. In some embodiments, step 906 involves receiving multiple inbound streams of persona data from multiple sources, where each of those multiple inbound streams of persona data include a respective one of the one or more other personas. And certainly other variants are possible as well, as deemed suitable by those of skill in the art.

At step 908, the computing system 104b presents (at 442) the full persona set 542 of the extracted persona 108b and the one or more other personas (e.g., the personas 108a and 108c) on the user interface 420 according to a common cross-client persona configuration. In at least one embodiment, step 908 involves formatting and sending to the user interface 420 a window that (i) includes each persona in the full persona set 542 arranged according to the common cross-client configuration and (ii) has substantially every other (if not every other) pixel set to be completely (or effectively or substantially) transparent; such other pixels include those pixels that would otherwise display a background around the personas, and also include those pixels that would otherwise display window elements such as borders, menus, a title bar, toolbars, buttons for minimization, maximization, closing the window, and so on.

In at least one embodiment, the inbound stream 538 of persona data includes audio data associated with the one or more other personas (108a and 108c), and step 908 involves presenting (e.g., playing) that audio data via the user interface 420. In some embodiments, any audio data associated with the extracted persona 108b is not presented by the computing system 104b via the user interface 420, so as not to distractingly (and likely with some delay) echo a user's own audio back to them. In at least one embodiment, any such audio data is included by the computing system 104b in the outbound stream 536, so as to be available to other computing systems such as the computing systems 104a and 104c.

In at least one embodiment, the at least one inbound stream 538 of persona data includes presentation metadata that conveys the common cross-client persona configuration, such that the computing system 104b can then use that included presentation metadata in order to present the full persona set 542 in accordance with the common cross-client persona configuration. In at least one embodiment, the common cross-client persona configuration specifies positioning and size data for each persona in the full persona set 542. In at least one embodiment, the common cross-client persona configuration specifies a positioning offset and a size of a respective display region for each persona in the full persona set. As an example, a positioning offset could be an {x,y} coordinate corresponding to a top-left corner of a rectangular display region while the size could be conveyed by a length value and a width value; and certainly other offset-and-size approaches could be used as well, as could other approaches in general to specifying a location, shape, and size of a display region for a given persona. In some embodiments, the common cross-client configuration specifies a positioning offset for one or more of the personas within their respective display regions. In at least one embodiment, the common cross-client persona configuration places the personas in the full persona set 542 in a horizontal row in which the personas are sequenced in a particular order; such is the case with the examples depicted in FIGS. 5 and 6.

In at least one embodiment, the common cross-client persona configuration specifies respective display sizes for the various personas. In at least one such embodiment, those display sizes are based at least in part on normalization of depth values respectively associated with the various personas. The associated video cameras 102 may provide image-depth data according to a common unit of measure (e.g., millimeters (mm)), and this data may be used by the computing system 104b or perhaps by the server 120 to normalize the sizes of the personas, making them appear to be of comparable size in spite of being captured at various image depths. Such image-depth data may more heavily weight data that pertains to a person's torso as compared with data that pertains to a person's head, for example, in order to generally stabilize the result of the normalization process. And certainly other approaches could be used as well, as deemed suitable by those of skill in the relevant art.

In at least one embodiment, step 908 involves presentation of a local copy of the (locally) extracted persona 108b. This approach conserves bandwidth in implementations in which the server 120 does not transmit persona data for a given persona to a given computing system 104 from which the server 120 received that given persona in the first place. In such cases, the server 120 may include metadata making clear the proper configuration for the overall display of the full persona set 542. This approach also tends to reduce potentially distracting video delay that is quite likely to occur when a persona that is being captured at a given computing system 104 is transmitted to the server 120 and back, and then displayed.

In at least one embodiment, the computing system 104b identifies the one or more other personas (e.g., the personas 108a and 108c) in the at least one inbound stream 538 of persona data at least in part by identifying and removing chroma keys included with those one or more other personas in the at least one inbound stream 538 of persona data. In some such embodiments, the computing system 104b further uses those identified chroma keys to generate respective alpha masks for those one or more other personas. The personas 108a and 108c are shown at 540 in FIG. 5 with their respective chroma keys; the correspondingly generated alpha masks are shown at 541. In a given instance, if a chroma key was royal purple, each royal-purple pixel becomes a “0” in the corresponding alpha mask, while each other pixel becomes a “1”. And certainly other examples could be given.

In such embodiments, the computing system 104b uses the generated alpha masks for presenting the associated personas as part of presenting the full persona set on the user interface. As depicted in FIG. 5, the locally captured persona 108b may be sent as a (perhaps cropped) video stream 534 along with a corresponding stream 535 of alpha masks. For presentation of a given persona in its respective region in the full persona set 542, the computing system 104b may display persona pixels at each pixel location having a value of “1” in the corresponding alpha mask, and may further display completely (or substantially or effectively completely) transparent pixels at each other pixel location (which would have a value of “0” in the alpha mask. In various different embodiments, each persona could have its own different respective chroma key. And certainly other approaches could be used.

At step 910, the computing system 104b presents (at 446) one or more shared-content channels 116 on the user interface 420 according to a common cross-client shared-content-channel configuration. In at least one embodiment, the computing system 104b maintains one or more ports for transmission of one or more shared-content channels 116 via the network 118 to one or more other computing systems. In at least one embodiment, the computing system 104b maintains one or more ports for receipt of one or more shared-content channels 116 via the network 118 to one or more other computing systems. In various different embodiments, the computing system 104b presents (e.g., displays) one or more shared-content channels 116 via the user interface 420, where each of those one or more shared-content channels originates either locally at the computing system 104b or remotely and is received by the computing system 104b via a network such as the network 118.

In at least one embodiment, presenting a given shared-content channel 116 on the user interface 420 involves (i) receiving (via, e.g., the network 118) an inbound shared-content-channel stream corresponding to the given shared-content channel 116, where that inbound shared-content-channel stream includes appearance data (i.e., what to display) and display-configuration data (i.e., how to display it) for the given shared-content channel and (ii) using the display-configuration data for the given shared-content channel 116 to display the appearance data for the given shared-content channel 116 in accordance with the common cross-client shared-content-channel configuration.

In at least one such embodiment, the at least one inbound stream 538 of persona data has an associated frame rate that exceeds that of the inbound shared-content-channel stream. And it is noted that, while streams of persona data are typically implemented using frame rates that exceed those of shared-content channels, this is not to the exclusion of other implementations, as in some embodiments the persona streams and the shared-content streams use equal frame rates, and in other embodiments the shared-content streams use frame rates that exceed those of the persona streams.

In one example, the shared-content channel 116 takes the form of a native web-browser window on the computing system 104b, where perhaps a user command (e.g., right-click→share . . . ) to share that window as a shared-content channel has been received by the computing system 104b. In that example, the computing system 104b formats both appearance data and display-configuration data (e.g., window size, window location, and the like) representative of that native web browser window on the user interface 420, and transmits an outbound shared-content-channel stream to one or more other computing systems (e.g., the computing systems 104a and 104c) for presentation on respective user interfaces according to the common cross-client shared-content-channel configuration. In at least one such embodiment, the at least one inbound stream 538 of persona data has an associated frame rate that exceeds that of the outbound shared-content-channel stream. And it is again noted that, while streams of persona data are typically implemented using frame rates that exceed those of shared-content channels, this is not to the exclusion of other implementations, as in some embodiments the persona streams and the shared-content streams use equal frame rates, and in other embodiments the shared-content streams use frame rates that exceed those of the persona streams. Moreover, such transmission could occur in a peer-to-peer manner, via one or more servers, and/or using one or more other communication approaches deemed suitable by those having skill in the art.

In at least one embodiment, the common cross-client shared-content-channel configuration specifies positioning data and size data for each of the one or more shared-content channels. In at least one embodiment, the common cross-client shared-content-channel configuration specifies relative positioning data (e.g., a back-to-front display order) among multiple shared-content channels. In at least one embodiment, the common cross-client shared-content-channel configuration specifies relative positioning data (e.g., relative {x,y} positioning data) between (i) one or more personas and (ii) one or more shared-content channels. In some embodiments, the computing system of the remote/receiving device may use pixel-based sizes and calculations for rendering both the personas and the shared content that don't change with the sender/receiver resolution or aspect ratio. Furthermore, some embodiments may be configured to use positioning data that is device independent. In at least one embodiment, the common cross-client shared-content-channel configuration is made up of (i) presentation metadata generated by the computing system 104b and (ii) presentation metadata received by the computing system 104b from one or more other computing systems. In the event that conflict or inconsistency resolution is needed among various instances of presentation metadata, a predetermined arbitration approach (e.g., first in time results in foreground display, most recent in time results in foreground display, and/or the like) could be used, or perhaps a host-to-host negotiation according to a negotiation protocol could be used. And certainly other approaches could be used as well, as deemed suitable by those of skill in the art.

In at least one embodiment, the computing system 104b operates in a featured-speaker mode in which one or more of the personas in the full persona set 542 are designated as featured-speaker personas, where the remaining personas in the full persona set 542 are designated as being non-featured-speaker personas, and where the common cross-client persona configuration emphasizes (e.g., increases in size, increases in opacity, highlights, centers, increases audio volume, and/or the like) each featured-speaker persona. In at least one such embodiment, the common cross-client persona configuration deemphasizes (e.g., decreases in size, increases in transparency, moves away from a center, hides, decreases audio volume, and/or the like) each non-featured-speaker persona. In various embodiments, the computing system 104b may receive a user command to assert or activate featured-speaker mode, and may responsively begin operating in featured-speaker mode. Such a user command may take the form of a menu selection, a gesture, voice activity, and/or any other type of user command deemed suitable by those of skill in the relevant art.

Although features and elements are described above in particular combinations, those having ordinary skill in the art will appreciate that each feature or element can be used alone or in any combination with the other features and elements without departing from the scope and spirit of the present disclosure.

What is claimed is:

1. A method comprising:
extracting a persona from video frames being received from a video camera;
transmitting an outbound stream of persona data, the outbound stream of persona data comprising the extracted persona;
receiving at least one inbound stream of persona data, the at least one inbound stream of persona data comprising one or more other personas;
presenting a full persona set of the extracted persona and the one or more other personas on a user interface according to a common cross-client persona configuration; and
presenting one or more shared-content channels on the user interface according to a common cross-client shared-content-channel configuration.

2. The method of claim 1, wherein receiving the at least one inbound stream of persona data comprises receiving a single inbound stream of persona data, the single inbound stream of persona data comprising the one or more other personas.

3. The method of claim 2, wherein receiving the single inbound stream of persona data comprises receiving the single inbound stream of persona data from a server that compiled multiple persona streams into the single inbound stream of persona data.

4. The method of claim 1, wherein receiving the at least one inbound stream of persona data comprises receiving multiple inbound streams of persona data from multiple sources, each of the multiple inbound streams of persona data comprising a respective one of the one or more other personas.

5. The method of claim 1, wherein the at least one inbound stream of persona data comprises audio data associated with the one or more other personas, and wherein presenting the full persona set on the user interface comprises presenting the audio data associated with the one or more other personas.

6. The method of claim 1, further comprising not presenting audio data associated with the extracted respective persona via the user interface.

7. The method of claim 1, wherein the at least one inbound stream of persona data comprises presentation metadata conveying the common cross-client persona configuration.

8. The method of claim 1, wherein the common cross-client persona configuration specifies positioning data and size data for each persona in the full persona set.

9. The method of claim 8, wherein the common cross-client persona configuration specifies a positioning offset and a size of a respective display region for each persona in the full persona set.

10. The method of claim 9, wherein the common cross-client persona configuration further specifies a respective in-region positioning offset for each persona in that persona's respective display region.

11. The method of claim 1, wherein the common cross-client persona configuration places the personas in the full persona set in a horizontal row in which the personas are sequenced in a particular order.

12. The method of claim 1, wherein the common cross-client persona configuration specifies respective display sizes for the various personas, the respective display sizes being based on normalization of depth values respectively associated with the various personas.

13. The method of claim 1, wherein presenting the full persona set on the user interface comprises presenting a local copy of the extracted persona.

14. The method of claim 1, further comprising formatting the extracted persona for transmission in the outbound stream of persona data as including frames consisting of a chroma key surrounding the extracted persona.

15. The method of claim 1, further comprising identifying the one or more other personas in the at least one inbound stream of persona data at least in part by identifying and removing chroma keys included with the one or more other personas in the at least one inbound stream of persona data.

16. The method of claim 15, further comprising using the identified chroma keys for generating respective alpha masks for the one or more other personas in the at least one inbound stream of persona data, and using the generated alpha masks for presenting the associated personas as part of presenting the full persona set on the user interface.

17. The method of claim 1, further comprising transmitting an outbound shared-content-channel stream corresponding to a given shared-content channel to one or more other computing systems, the outbound shared-content-channel stream comprising appearance data for the given shared-content channel and display-configuration data for use by each of the one or more other computing systems in presenting the shared-content channel in accordance with the common shared-content-channel configuration.

18. The method of claim 17, wherein the outbound shared-content-channel stream has an associated first frame rate, and wherein the at least one inbound stream of persona data has an associated second frame rate that exceeds the first.

19. The method of claim 17, wherein the appearance data for the given shared-content channel reflects an appearance of a native application window currently being displayed on the user interface.

20. The method of claim 1, wherein presenting a given shared-content channel on the user interface comprises:
receiving an inbound shared-content-channel stream corresponding to the given shared-content channel, the inbound shared-content-channel stream comprising appearance data and display-configuration data for the given shared-content channel; and
using the display-configuration data for the given shared-content channel to display the appearance data for the given shared-content channel in accordance with the common cross-client shared-content-channel configuration.

21. The method of claim 20, wherein the inbound shared-content-channel stream has an associated first frame rate, and wherein the at least one inbound stream of persona data has an associated second frame rate that exceeds the first.

22. The method of claim 1, further comprising operating in a featured-speaker mode in which one or more of the personas in the full persona set are designated as featured-speaker personas, the remaining personas in the full persona set being non-featured-speaker personas, wherein the common cross-client persona configuration emphasizes each featured-speaker persona.

23. The method of claim 22, wherein the common cross-client persona configuration deemphasizes each non-featured-speaker persona.

24. The method of claim 1, wherein the common cross-client persona configuration specifies positioning data and size data for each of the one or more shared-content channels.

25. The method of claim 1, wherein the common cross-client persona configuration specifies relative positioning data among multiple shared-content channels.

26. The method of claim 1, wherein the common cross-client persona configuration specifies relative positioning data between (i) one or more personas and (ii) one or more shared-content channels.

27. A computing system comprising:
a persona-extraction module configured to extract a persona from video frames being received from a video camera;
a persona-transmission module configured to transmit an outbound stream of persona data comprising the extracted persona;
a persona-reception module configured to receive at least one inbound stream of persona data, the at least one inbound stream of persona data comprising one or more other personas;
a persona-set-presentation module configured to present the extracted persona and the one or more other personas on a user interface according to a common cross-client persona configuration; and
a shared-content-channel-presentation module configured to present one or more shared-content channels on the user interface according to a common cross-client shared-content-channel configuration.
